(19) United States
(12) Patent Application Publication
(10) Pub. No.: US 2025/0326010 A1
(43) Pub. Date: Oct. 23, 2025

(54) Culvert-Clearing System

(71) Applicant: Rudolph Leskosek, Red Deer (CA)

(72) Inventor: Rudolph Leskosek, Red Deer (CA)

(21) Appl. No.: 19/175,197

(22) Filed: Apr. 10, 2025

Related U.S. Application Data
(60) Provisional application No. 63/634,981, filed on Apr. 17, 2024.

(51) Int. Cl. B08B 9/043; E01F 5/00

(52) U.S. Cl. CPC B08B 9/0436; E01F 5/005

(57) ABSTRACT

A culvert-clearing system is provided. The system includes a base plate with alignment features, a pivotable winch assembly, and a scraper mechanism designed for bidirectional movement through a culvert. The winch assembly may be hydraulically powered and optionally retrofitted to existing winches using a conversion kit that integrates a hydraulic motor with a drive shaft via an adapter plate and coupler. The hydraulic motor is operated via a control unit and pump system to ensure proper torque delivery. A scraper assembly with angled arms and teeth is connected to a winch cable routed through a pulley assembly anchored at the far end of the culvert, enabling effective debris dislodgment and transport toward an accessible opening.

### CROSS-REFERENCE TO RELATED APPLICATION

The present application claims priority to, and the benefit of, U.S. Provisional Application No. 63/634,981, which was filed on Apr. 17, 2024, and is incorporated herein by reference in its entirety.

### FIELD OF THE INVENTION

The present invention relates generally to the field of culverts. More specifically, the present invention relates to a culvert-clearing system for cleaning debris from culverts. Accordingly, the present disclosure makes specific reference thereto. Nonetheless, it is to be appreciated that aspects of the present invention are also equally applicable to other like applications, devices, and methods of manufacture.

### BACKGROUND

Culverts are essential components of infrastructure, allowing water to pass beneath roadways and other structures. When culverts become obstructed with debris such as rock, sediment, or organic matter, the resulting blockages can cause significant consequences, including upstream flooding, road washouts, and traffic disruptions. These issues can lead to costly infrastructure damage, increased maintenance expenses, and risk to public safety. Traditional culvert cleaning methods often involve sending personnel into confined spaces, which presents serious safety hazards, including the risk of entrapment, collapse, or exposure to harmful materials. Moreover, manual clearing is time-consuming and inefficient, requiring extended road closures or traffic diversions that impact transportation flow. In some cases, complete culvert replacement is required due to inaccessibility or damage, leading to prolonged construction projects and environmental disruption. The use of heavy machinery near delicate drainage systems can also risk damaging the culvert structure or surrounding terrain. Consequently, there exists a demand for a safer, more efficient, and less invasive method to clean culverts and restore water flow with minimal disruption.

Therefore, there exists a long-felt need in the art for a culvert cleaning system that enables efficient removal of debris from culverts without requiring personnel to enter confined or hazardous environments. There also exists a long-felt need in the art for a culvert cleaning system that minimizes disruption to traffic flow and avoids the need for full culvert replacement during routine maintenance. Moreover, there exists a long-felt need in the art for a culvert cleaning system that protects the structural integrity of the culvert and surrounding area while removing compacted debris with minimal environmental impact.

The subject matter disclosed and claimed herein, in one embodiment thereof, comprises a culvert-clearing system for cleaning debris from culverts. The system includes a base plate with alignment features, a pivotable winch assembly, and a scraper mechanism designed for bidirectional movement through a culvert. The winch assembly may be hydraulically powered and optionally retrofitted to existing winches using a conversion kit that integrates a hydraulic motor with a drive shaft via an adapter plate and coupler. The hydraulic motor is operated via a control unit and pump system to ensure proper torque delivery. A scraper assembly with angled arms and teeth is connected to a winch cable routed through a pulley assembly anchored at the far end of the culvert, enabling effective debris dislodgment and transport toward an accessible opening. A method of use includes aligning the winch assembly, routing the cable using a guide conduit, attaching the scraper and debris-removal bucket, and cyclically operating the winch to remove debris while maintaining continuous alignment with the culvert's geometry.

In this manner, the culvert-clearing system of the present invention accomplishes all the forgoing objectives and enables the cleaning of culverts using a scraper and bucket mechanism powered by a two-drum winch assembly. The system mounts onto existing machinery or a standalone base plate, allowing flexible deployment based on site conditions. The winch and pulley configuration enables bidirectional scraping through the culvert without requiring entry by workers, thereby enhancing safety. The scraper arm and bucket assembly effectively dislodges and removes debris while minimizing contact with culvert surfaces, reducing the risk of damage. The hydraulic conversion kit allows for the adaptation of existing winches to a hydraulic power source, improving force output and operational control. Furthermore, the system's design supports use in restricted-access areas through auxiliary anchoring and offset arrangements. As a result, the culvert cleaning system provides an efficient, scalable, and non-invasive solution to the persistent challenges associated with culvert maintenance.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a culvert-clearing system. The system is comprised of a base plate that provides a mounting foundation for a winch assembly. The base plate includes alignment holes for adjustable positioning of the winch assembly and may include an attachment point for connection to machinery such as a skid steer.

The winch assembly is comprised of a winch housing that may include a cylindrical socket configured to receive a pivot pin from the base plate. The pivot pin enables horizontal swiveling of the winch assembly to align with the culvert and includes a lift hole for tool-free removal. The winch assembly is attached to the base plate via a fastener and may be powered by a generator, air compressor, or other power source.

In one embodiment, the winch is a hydraulic-powered slusher winch. The system may also include a conversion kit for retrofitting existing air-powered or electric-powered winches into hydraulic-powered operation. The conversion kit is comprised of an adapter plate configured to interface with the drive shaft of an existing winch and transmit torque from a hydraulic motor. The drive shaft is engaged by at least one coupler configured to transmit rotational force from the hydraulic motor. The coupler may be selected based on shaft geometry and load requirements. At least one hydraulic motor is mounted to the adapter plate and secured using a fastener. The motor is configured to deliver sufficient torque to operate the winch and may be selected from orbital motors, vane motors, or gear motors. The adapter plate is also secured to the winch housing or mounting frame. The hydraulic motor is fluidly connected to a hydraulic control unit via a hydraulic hose. The control unit includes flow control components for regulating the speed, direction, and torque output of the hydraulic motor. The hydraulic control unit is fluidly connected to a hydraulic pump via the hydraulic hose. The pump supplies pressurized fluid to the control unit and may be powered by an external engine or electric motor. The pump type is selected based on flow rate and pressure capacity.

The system is also comprised of a scraper assembly comprising a scraper arm connected to a scraper body. The scraper body is welded to the arm at an angle to maximize gouging and gliding. Hardened steel scraper teeth are affixed along the forward edge of the scraper body for debris penetration. A front clevis connects the scraper arm to the primary winch cable, while a rear sling connects the scraper assembly to a debris-removal bucket.

An auxiliary anchor point is located at the opposite end of the culvert for use where machinery access is limited. The anchor point may be a ground stake, buried anchor, or fixed structural member and includes attachment points for a pulley assembly. The primary winch cable is routed through the culvert, around the pulley assembly, and returned to the scraper and bucket assembly. The pulley assembly is secured to an anchor point using a pulley clevis.

The invention also includes a method of use. The base plate, winch assembly, scraper arm and body, winch cable, and pulley assembly are first provided. The winch assembly is aligned with the culvert by adjusting the base plate and pivoting the winch. The winch may be mounted on a truck deck or other structure. A guide path is created through the culvert using a conduit and rope, and the winch cable is pulled through using this guide. The pulley assembly is mounted to the auxiliary anchor point, and the cable is routed to form a continuous loop through the culvert. The scraper arm is attached to the cable, and the rear sling is connected to a debris-removal bucket. Power is applied to the winch to move the scraper and bucket bidirectionally, dislodging and transporting debris. The debris is extracted externally, and the process is repeated until the culvert is cleared.

Accordingly, the culvert-clearing system of the present invention is particularly advantageous as it enables the cleaning of culverts using a scraper and bucket mechanism powered by a two-drum winch assembly. The system mounts onto existing machinery or a standalone base plate, allowing flexible deployment based on site conditions. The winch and pulley configuration enables bidirectional scraping through the culvert without requiring entry by workers, thereby enhancing safety. The scraper arm and bucket assembly effectively dislodges and removes debris while minimizing contact with culvert surfaces, reducing the risk of damage. The hydraulic conversion kit allows for the adaptation of existing winches to a hydraulic power source, improving force output and operational control. Furthermore, the system's design supports use in restricted-access areas through auxiliary anchoring and offset arrangements. As a result, the culvert cleaning system provides an efficient, scalable, and non-invasive solution to the persistent challenges associated with culvert maintenance. In this manner, the culvert-clearing system overcomes the limitations of existing methods and devices used that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of an adapter plate of one potential embodiment of a culvert-clearing system of the present invention in accordance with the disclosed architecture;

FIG. 2 illustrates a bottom view of a base plate of one potential embodiment of a culvert-clearing system of the present invention in accordance with the disclosed architecture;

FIG. 3 illustrates a perspective view of a winch assembly attached to an adapter plate of one potential embodiment of a culvert-clearing system of the present invention in accordance with the disclosed architecture;

FIG. 4 illustrates a side perspective view of an adapter plate of one potential embodiment of a culvert-clearing system of the present invention while attached to a skid steer attachment point in accordance with the disclosed architecture;

FIG. 5 illustrates a top perspective view of a scraper assembly of one potential embodiment of a culvert-clearing system of the present invention in accordance with the disclosed architecture;

FIG. 6 illustrates a perspective view of a pulley assembly attached to an anchor point of one potential embodiment of a culvert-clearing system of the present invention in accordance with the disclosed architecture;

FIG. 7 illustrates a perspective view of a debris-removal bucket of one potential embodiment of a culvert-clearing system of the present invention in accordance with the disclosed architecture;

FIG. 8 illustrates a top diagrammatic view of one potential embodiment of a culvert-clearing system of the present invention in accordance with the disclosed architecture;

FIG. 9 illustrates a top diagrammatic view of one potential embodiment of a culvert-clearing system of the present invention in an offset configuration in accordance with the disclosed architecture;

FIG. 10 illustrates a top diagrammatic view of a guide rod and rope of one potential embodiment of a culvert-clearing system of the present invention being fed through a culvert in accordance with the disclosed architecture;

FIG. 11 illustrates a side diagrammatic view of a winch kit of one potential embodiment of a culvert-clearing system of the present invention in accordance with the disclosed architecture; and

FIG. 12 illustrates a flowchart of a method of using one potential embodiment of a culvert-clearing system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a culvert cleaning system that enables efficient removal of debris from culverts without requiring personnel to enter confined or hazardous environments. There also exists a long-felt need in the art for a culvert cleaning system that minimizes disruption to traffic flow and avoids the need for full culvert replacement during routine maintenance. Moreover, there exists a long-felt need in the art for a culvert cleaning system that protects the structural integrity of the culvert and surrounding area while removing compacted debris with minimal environmental impact.

The present invention, in one exemplary embodiment, is comprised of a culvert-clearing system. The culvert-cleaning system is comprised of a base plate that serves as a mounting foundation for a winch assembly. The base plate includes alignment holes for adjustable positioning and may feature an attachment point for connection to machinery such as a skid steer. The winch assembly is comprised of a winch housing that may include a cylindrical socket for receiving a pivot pin, allowing horizontal swiveling to align with the culvert. The pivot pin includes a lift hole for tool-free removal. The winch assembly is secured to the base plate using a fastener and may be powered by a generator, air compressor, or other power source. In one embodiment, the winch is a hydraulic-powered slusher winch. A conversion kit may also be included for retrofitting air-powered or electric-powered winches for hydraulic operation. This kit is comprised of an adapter plate that interfaces with the existing winch's drive shaft and transmits torque from a hydraulic motor, which is fluidly connected to a hydraulic control unit and hydraulic pump.

The system further includes a scraper assembly comprising a scraper arm connected to a scraper body. The scraper body is welded at an angle to the arm to enhance gouging and gliding action. Hardened steel scraper teeth are affixed to the forward edge of the scraper body for penetrating debris. A front clevis attaches the scraper arm to the winch cable, while a rear sling connects the scraper assembly to a debris-removal bucket. At the opposite end of the culvert, an auxiliary anchor point may be used where machinery access is restricted. The anchor point includes attachment features for a pulley assembly. The winch cable is routed through the culvert, around the pulley assembly, and back to the scraper and bucket assembly. The pulley assembly is secured using a pulley clevis.

A method of use includes positioning the winch assembly using the base plate and pivot pin to align with the culvert. A guide path is established using a conduit and rope, through which the winch cable is routed. The pulley assembly is mounted to the auxiliary anchor point to create a continuous cable loop through the culvert. The scraper arm is attached to the cable, and the rear sling is connected to a debris-removal bucket. Power is applied to the winch to move the scraper and bucket bidirectionally, dislodging and transporting debris. The debris is extracted externally, and the process is repeated until the culvert is clear. The system provides a scalable, efficient, and non-invasive solution for culvert maintenance, supporting flexible deployment, safe operation, and compatibility with restricted-access environments.

Referring initially to the drawings,

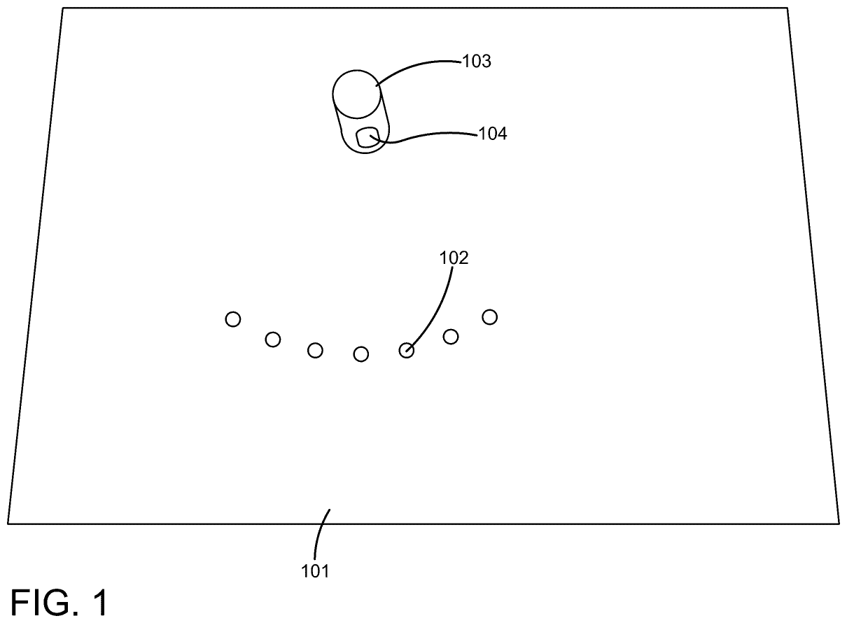

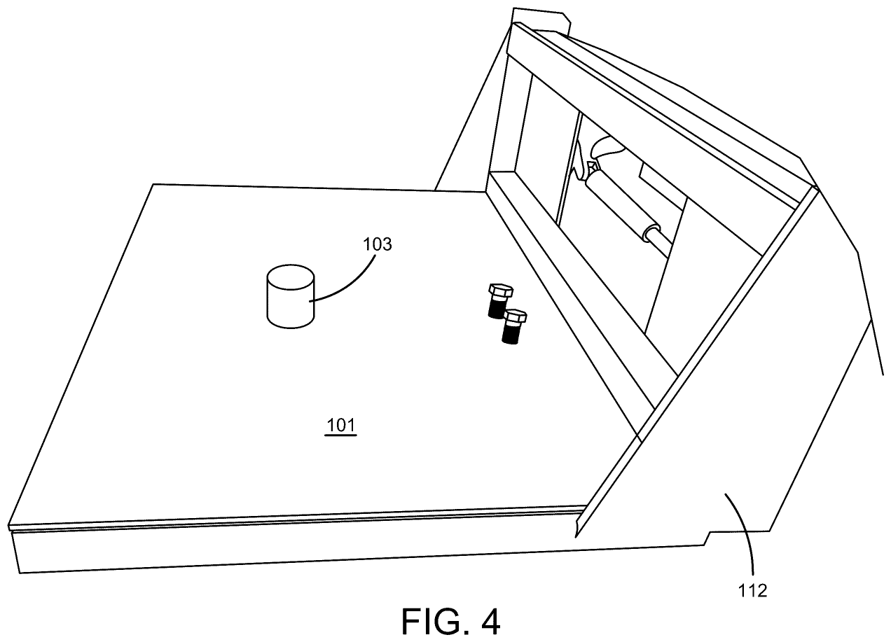

The present invention is comprised of a system 100 for removing debris from culverts. As seen in FIG. 1, the system 100 is comprised of a base plate 101 that provides a mounting foundation for the winch assembly 115. The plate 101 includes a pattern of alignment holes 102 that are arranged to allow selective mounting and angular orientation of the winch assembly 115 based on the geometry of the culvert. In one embodiment, the holes 102 are threaded. In a further embodiment, the base plate 101 is comprised of an attachment point 112 for a skid steer or other machinery, as seen in FIG. 4.

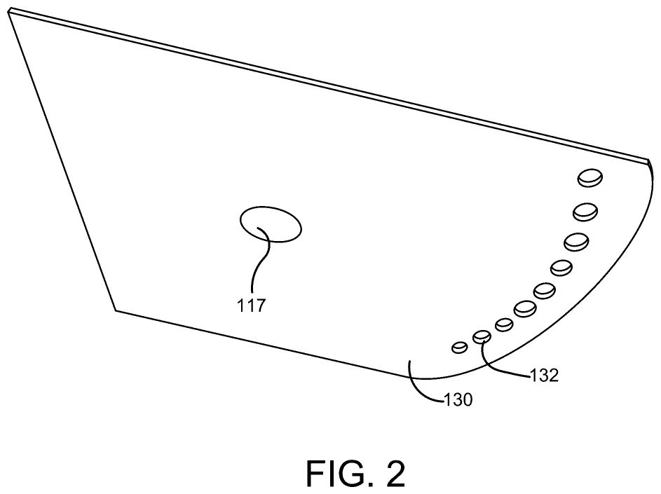

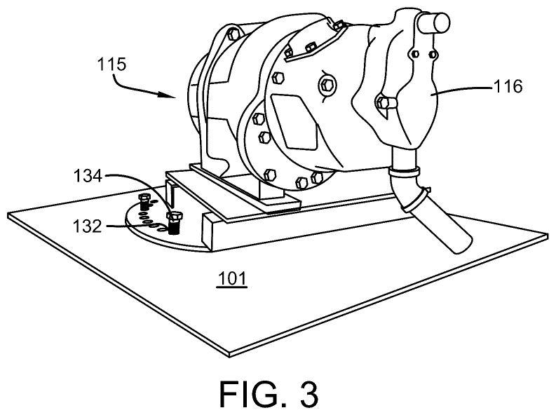

The winch assembly 115 is comprised of a winch housing 116, as seen in FIG. 3. The housing 116 and/or base plate 130 (as will be explained more fully below) may include a cylindrical socket 117 (as seen in FIG. 2) that receives a pivot pin 103 of the base plate 101. The pivot pin 103 enables the winch assembly 115 to swivel horizontally, aligning the winch cable 114 with the culvert opening regardless of the direction of cable pull. The pivot pin 103 is further comprised of a lifting hole 104 formed transversely through the pivot pin 103 to enable tool-free extraction of the pivot pin 103 from the plate 101 using a lifting hook or rod, allowing rapid removal of the winch assembly 115 when not in use. In one embodiment, the winch assembly 115 is comprised of a base plate 130 with at least one opening 132 that allows the winch assembly 115 to be attached to the base plate 101 via a fastener 134 such as but not limited to a bolt. The winch assembly 115 may be powered by at least one power source 150 such as but not limited to a generator, and air compressor, etc.

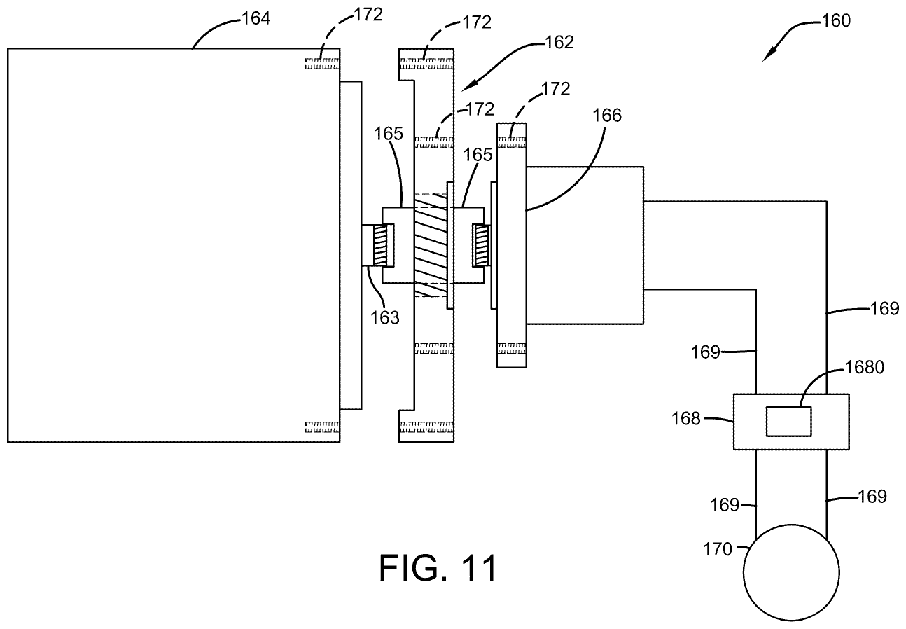

In one embodiment, the winch 115 is preferably a hydraulic-powered slusher winch. In a further embodiment, the system 100 is comprised of a conversion kit 160 configured to retrofit an existing air-powered winch 164 or electric-powered winch into a hydraulic-powered winch 164, as seen in FIG. 11. The conversion kit 160 is comprised of an adapter plate 162, which is configured to interface with a drive shaft 163 of an existing winch 164. The adapter plate 162 provides a mechanical mounting interface and torque transmission coupling between the hydraulic motor and the existing winch 164.

The drive shaft 163 of the winch 164 is mechanically engaged by at least one coupler 165. The coupler 165 is configured to transmit rotational force from the hydraulic motor 166 to the drive shaft 163. The coupler 165 may include, but is not limited to, a keyed shaft coupler, flexible disc coupling, or spline coupling, depending on the shaft geometry and load requirements.

At least one hydraulic motor 166 is mounted to the adapter plate 162. The hydraulic motor 166 may be selected from orbital motors, vane motors, gear motors, etc. and is configured to deliver rotational output torque sufficient to operate the winch 164 under expected load conditions. The motor 166 is secured to the adapter plate 162 via at least one fastener 167. The fastener 167 may include threaded bolts, machine screws, or locking pins, and may interface with threaded holes 172 or reinforced brackets on the plate 162, motor 166, and/or existing winch 164. The adapter plate 162 is further secured to the housing or mounting frame of the winch 164 using the fastener 167.

The hydraulic motor 166 is fluidly connected to at least one hydraulic control unit 168 via at least one hydraulic hose 169. The hydraulic control unit 168 may include flow control components 1680 configured to regulate the speed, direction, and torque output of the hydraulic motor 166.

The hydraulic control unit 168 is further fluidly connected to at least one hydraulic pump 170 via the hydraulic hose 169. The hydraulic pump 170 supplies pressurized fluid to the hydraulic control unit 168 and may be powered by an external engine, electric motor, or other prime mover. The hydraulic pump 170 may be a gear pump, piston pump, or vane pump, selected based on the required flow rate and pressure capacity.

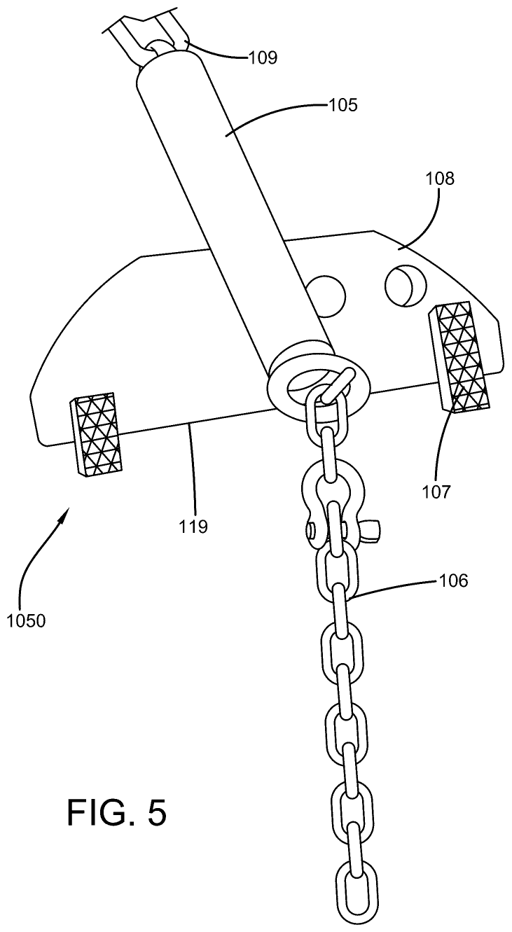

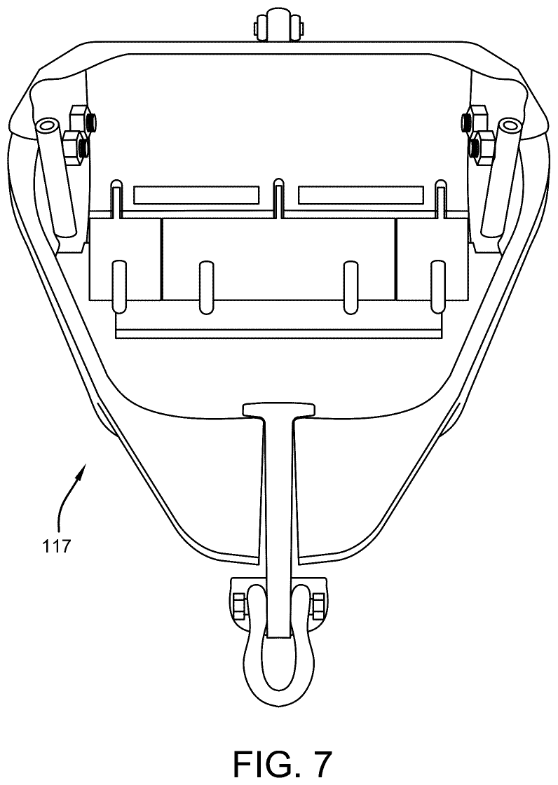

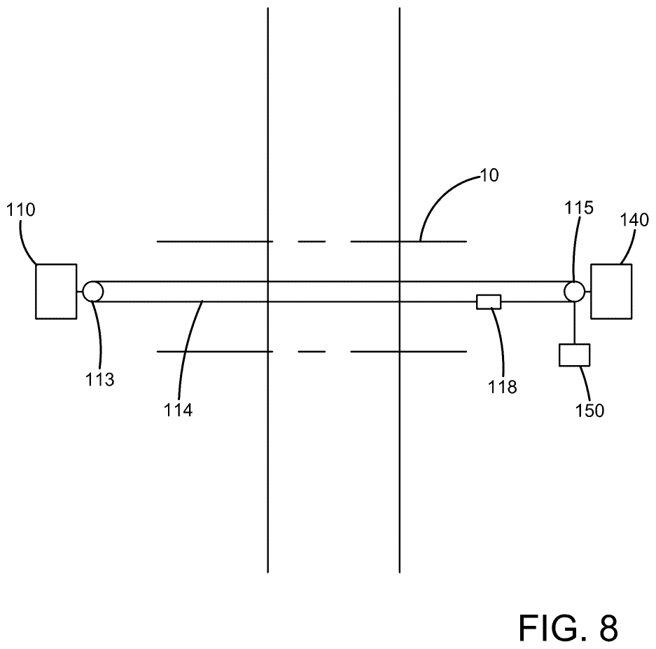

The system 100 is also comprised of a scraper assembly 1050, as seen in FIG. 5, comprised of a scraper arm 105 that connects to a scraper body 108. The scraper body 108 is welded to the scraper arm 105 at an angle of approximately (but not limited to) 30 degrees relative to a horizontal axis of the arm 105 to maximize both gouging and gliding during bidirectional travel. A row of hardened steel scraper teeth 107 are affixed along the forward edge 119 of the scraper body 108 to penetrate and break up compacted debris. A front clevis 109 is mounted to the forward end of the scraper arm 105 and serves as an attachment point for a primary winch cable 114. A rear sling 106, formed from a chain or reinforced synthetic strap, links the rear of the scraper assembly 1050 to a debris-removal bucket 118, as seen in FIG. 8 and FIG. 7.

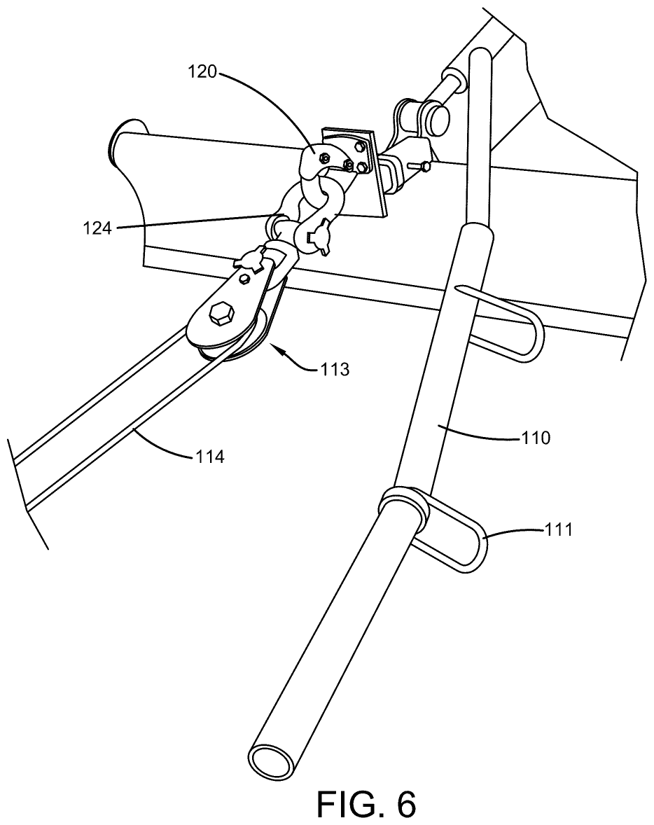

At the opposite end of the culvert, where access by heavy machinery may be impractical, an auxiliary anchor point 110 (as seen in FIG. 6) may be used. The auxiliary anchor point 110 may comprise a ground stake, buried deadman anchor, or fixed structural member embedded in concrete or soil. In one embodiment, the anchor point 110 is comprised of additional attachment points 111 enabling secure installation of a pulley assembly 113. The primary winch cable 114, preferably made from galvanized steel wire rope or synthetic fiber is routed from the winch assembly 115 through the culvert, around the pulley assembly 113, and returned through the culvert to connect with the scraper and bucket assembly. A pulley clevis 124 secures the pulley assembly 113 to an anchor point 120, such as but not limited to a piece of machinery.

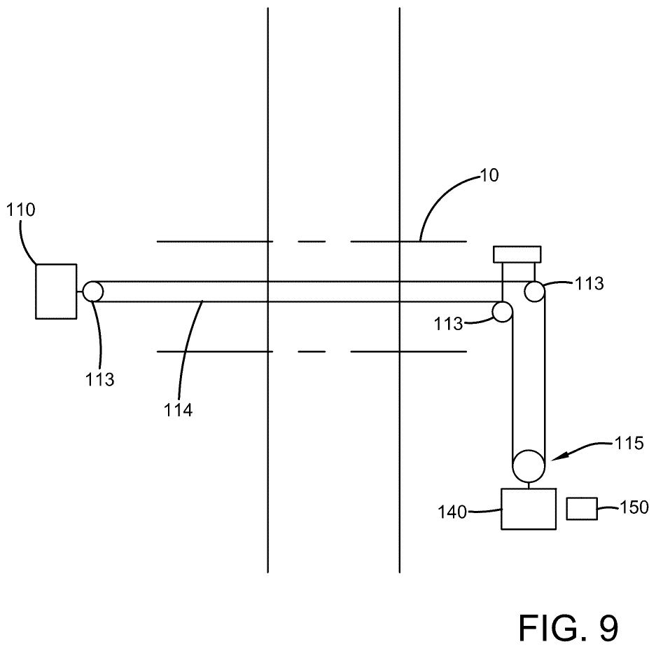

A preferred arrangement of the system 100 is shown in FIG. 8, An offset arrangement of the system 100 can be used where there is restricted access to a culvert 10, as seen in FIG. 9.

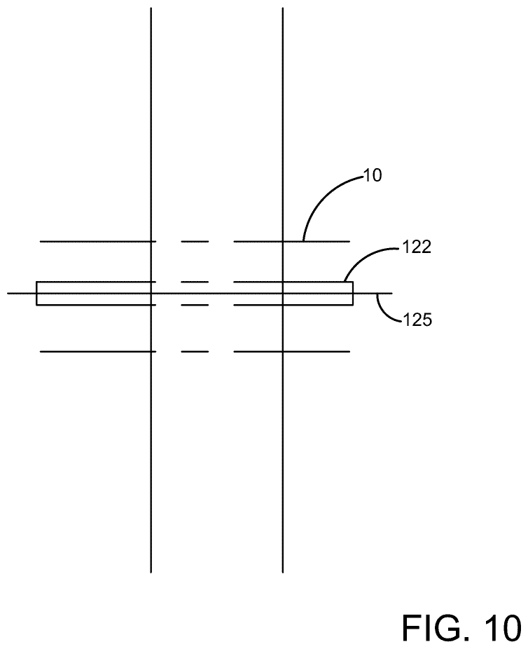

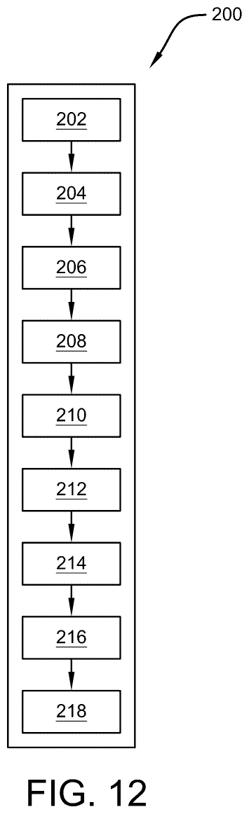

The present invention is also comprised of a method of using 200 the culvert cleaning system, as seen in FIG. 12. First, a culvert cleaning system is provided comprised of a base plate 101, a winch assembly 115 attached to the plate 101, a scraper arm 105 connected to a scraper body 108 having scraper teeth 107, a front clevis 109 and a rear sling 106, a winch cable 114, and a pulley assembly 115 secured to an auxiliary anchor point 120 via a pulley clevis 124 [Step 202]. Then, the winch assembly 115 is aligned with the opening of a culvert by positioning the plate 101 and rotating the winch 115 via the pivot pin 103 to accommodate the culvert's geometry [Step 204]. The winch assembly 115 may be mounted either to a truck deck using the plate 101 or to a piece of equipment or other structure via the clevis 124 [Step 206]. Next, a plastic conduit or flexible rod 122 is inserted through the culvert to establish a guide path, and a rope 125 is threaded through the conduit, as seen in FIG. 10 [Step 208]. The primary winch cable 114 is then attached to the rope 125 and pulled through the culvert from the winch 115 side to the far side using the guide path 122 [Step 206]. The pulley assembly 113 is then mounted to the auxiliary anchor point 120 using the pulley clevis 124 [Step 208]. The primary winch cable 114 is then routed through the pulley assembly 115 and returned through the culvert to the scraper assembly 1050, establishing a continuous cable path [Step 208]. Following this, the scraper arm 105 is attached to the primary winch cable 114 via the front clevis 109, and the rear sling 110 is connected to a debris-removal bucket 118 [Step 210]. The rear sling 110 may also connect to a second winch cable 114 in one embodiment, enabling bidirectional control of the scraper body 107 [Step 212]. Power is then applied to the winch assembly 115, using either pneumatic, electric, or hydraulic means, and the winch 115 is operated to move the scraper body 108 and the debris-removal bucket 118 back and forth through the culvert [Step 214]. As the scraper body 108 moves forward, the scraper teeth 107 engage and break up compacted debris. On the return stroke, the scraper arm 105 lifts or tilts and pulls debris toward the opening of the culvert. The debris is then extracted using external equipment 140 such as a loader bucket, and the cleaning cycle is resumed [Step 216]. These steps are repeated until the culvert is cleared of obstruction [Step 218].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “culvert-clearing system” and “system” are interchangeable and refer to the culvert-clearing system 100 of the present invention.

Notwithstanding the forgoing, the culvert-clearing system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the culvert-clearing system 100 as shown in the FIGS. are for illustrative purposes only, and that many other sizes and shapes of the culvert-clearing system 100 are well within the scope of the present disclosure. Although the dimensions of the culvert-clearing system 100 are important design parameters for user convenience, the culvert-clearing system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A culvert-clearing system comprising:
a base plate;
a winch mounted to the base plate;
a scraper assembly comprising a scraper arm, a scraper body connected to the scraper arm at an angle, a scraper tooth, a front clevis mounted to the scraper arm, and a rear sling;
a pulley assembly; and
a winch cable routed through a culvert and configured to connect to the front clevis and to the rear sling.

2. The culvert-clearing system of claim 1, wherein the base plate is comprised of an alignment hole.

3. The culvert-clearing system of claim 2, wherein the alignment hole is threaded.

4. The culvert-clearing system of claim 1, wherein the base plate is comprised of a pivot pin.

5. The culvert-clearing system of claim 1, wherein the base plate is comprised of an attachment point.

6. The culvert-clearing system of claim 1 further comprised of a power source.

7. The culvert-clearing system of claim 6, wherein the power source is comprised of a generator or an air compressor.

8. The culvert-clearing system of claim 1, wherein the winch is comprised of a hydraulic winch.

9. The culvert-clearing system of claim 1 further comprised of a debris removal bucket.

10. The culvert-clearing system of claim 1 further comprised of an auxiliary anchor point.

11. A culvert-clearing system comprising:
a base plate;
a winch mounted to the base plate;
a kit comprising an adapter plate, a coupler, a hydraulic motor, a hydraulic control unit, and a hydraulic pump;
a scraper assembly comprising a scraper arm, a scraper body connected to the scraper arm at an angle, a scraper tooth, a front clevis mounted to the scraper arm, and a rear sling;
a pulley assembly; and
a winch cable routed through a culvert and configured to connect to the front clevis and to the rear sling.

12. The culvert-clearing system of claim 11, wherein the winch is comprised of an electric winch.

13. The culvert-clearing system of claim 11, wherein the winch is comprised of an air-powered winch.

14. The culvert-clearing system of claim 11, wherein the hydraulic motor attaches to the adapter plate.

15. The culvert-clearing system of claim 14, wherein the adapter plate attaches to the winch.

16. The culvert-clearing system of claim 11, wherein the hydraulic motor is in fluid communication with a hydraulic pump.

17. The culvert-clearing system of claim 11, wherein the scraper tooth is positioned on a forward edge of the scraper body.

18. The culvert-clearing system of claim 11 further comprised of a debris removal bucket.

19. The culvert-clearing system of claim 11 further comprised of an auxiliary anchor point.

20. A method of using a culvert-clearing system, the method comprising:
providing a culvert-clearing system comprised of a base plate, a winch attached to the base plate, a scraper arm connected to a scraper body having a scraper tooth, a front clevis and a rear sling, a winch cable, and a pulley assembly secured to an auxiliary anchor point via a pulley clevis;
positioning the base plate and rotating the winch via a pivot pin to align the winch with a culvert;
inserting a flexible rod or conduit through the culvert to create a guide path;
threading a rope through the guide path and using the rope to pull the winch cable through the culvert;
mounting the pulley assembly to the auxiliary anchor point and routing the winch cable through the pulley and back through the culvert;
attaching the scraper arm to the winch cable via the front clevis and connecting the rear sling to a debris-removal bucket;
applying power to the winch and operating the winch to move the scraper assembly and debris-removal bucket through the culvert; and
repeating the movement until the culvert is cleared of a debris.
